(19) United States
(12) Patent Application Publication
(10) Pub. No.: US 2016/0321612 A1
(43) Pub. Date: Nov. 3, 2016

(54) OPEN DESIGN MANAGEMENT SERVER

(71) Applicant: Toshihiko Nakazawa, Tokyo (JP)

(72) Inventor: Toshihiko Nakazawa, Tokyo (JP)

(21) Appl. No.: 15/137,808

(22) Filed: Apr. 25, 2016

(30) Foreign Application Priority Data
May 1, 2015 (JP) 2015-094275
Jan. 26, 2016 (JP) 2016-012022

(51) Int. Cl. G06Q 10/10; G06F 3/14; H04L 29/06

(52) U.S. Cl. CPC G06Q 10/101; H04L 67/42; G06F 3/14

(57) ABSTRACT

In an open design management server, a project managing unit (a) transmits design demand posting screen data to a terminal device and creates a design project for a design demand in a database when receiving a post of the design demand from the terminal device; (b) transmits proposal posting screen data of a solution for the design demand to a terminal device and stores a proposal of a design concept in the database when receiving a post of the proposal from the terminal device; (c) creates a design frame for the proposal in the database when receiving a creation request and stores the created design frame; and (d) transmits screen data to a terminal device for displaying a relationship between the design demand and the proposal associated with each other and a relationship between the proposal and the design frame associated with each other, and causes the terminal device to display the relationships.

### REFERENCE TO RELATED APPLICATIONS

This application relates to and claims priority rights from Japanese Patent Application No. 2015-094275, filed on May 1, 2015 and Japanese Patent Application No. 2016-012022, filed on Jan. 26, 2016, the entire disclosures of which are hereby incorporated by reference herein.

### BACKGROUND

1. Field of the Present Disclosure

The present disclosure relates to an open design management server.

2. Description of the Related Art

In a first system, a user who conceived a design idea registers the design idea in a web site, and a company or the like can browse the design idea registered in the web site.

In another second system, a server publicly invites a design idea on a specific theme, and enables a posted design idea to be browsed.

### SUMMARY

In the aforementioned first system, when a company has a certain design demand (i.e. a matter that the company wants to realize), such company wants to adopt a design idea that meets the design demand, but such company can hardly find a design idea that meets the design demand.

In the aforementioned first and second systems, a specific design for the design idea (i.e. designing a product, an equipment or the like) is completely carried out inside the company (i.e. inside the company that adopted the design idea in the first system or inside the company that indicated the theme in the second system), and therefore, a person who posted the design idea does not have a chance that he/she knows: (a) whether the design idea will be materialized or not, (b) a progress status of the specific design for materializing the design idea, (c) what specific design finally materialized the design idea, and the like.

Further, in the aforementioned first and second systems, a user who does not participate in design work can also hardly browse information on such design work for materializing a proposal of a design concept (i.e. design idea) posted for a design demand.

Meanwhile, on the net, it is attempted to establish a design forum for open design (i.e. a service that many users as a specific or unspecified persons can participate) and discuss a solution for a design demand in the design forum. However, in such system, many miscellaneous design ideas are posted, and thereby the discussion is widely diverged and comes to end without any outcome. Thus, it is difficult to realize effective open design.

An open design management server according to an aspect of the present disclosure includes: a communication device; a frontend processing unit that receives a post and a request using the communication device, the post and the request transmitted from plural terminal devices operated by plural users; and a project managing unit that manages a design project using a database and performs a process corresponding to the received post or request for the design project. The project managing unit (a) transmits design demand posting screen data using the frontend processing unit to the terminal device, and creates a design project for a design demand in the database when a post of the design demand is received by the frontend processing unit from the terminal device, the design demand inputted to an input field displayed on the basis of the design demand posting screen data in the terminal device; (b) transmits proposal posting screen data of a solution for the design demand using the frontend processing unit to the terminal device, and stores a proposal of a design concept in the database so as to associate the proposal with the design demand when a post of the proposal is received by the frontend processing unit from the terminal device, the proposal inputted to an input field displayed on the basis of the proposal posting screen data in the terminal device, and the one or plural proposals enabled to be associated with the single design demand; (c) creates a design frame in the database when a creation request of a design frame for the proposal is received by the frontend processing unit from the terminal device, and stores the created design frame so as to associate the design frame with the proposal, the design frame capable of describing a series of design work materializing the design demand in accordance with the proposal, and the one or plural design frames enabled to be associated with the single proposal; and (d) transmits screen data to the terminal device for displaying a relationship between the design demand and the proposal associated with each other in the database, and a relationship between the proposal and the design frame associated with each other in the database, and causes the terminal device to display the relationships.

A server program according to an aspect of the present disclosure causes a computer in a server to act as the aforementioned frontend processing unit and the aforementioned project managing unit.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an open design management server according to embodiments of the present disclosure;

FIG. 2 shows a diagram that explains a data structure of a relational database managed by the open design management server 1 shown in FIG. 1;

FIG. 3 shows a diagram that indicates an example of a project list displayed by the terminal device 3 shown in FIG. 1;

FIG. 4 shows a diagram that indicates an example of a project page displayed by the terminal device 3 shown in FIG. 1;

FIG. 5 shows a diagram that indicates another example of a project page displayed by the terminal device 3 shown in FIG. 1;

FIG. 6 shows a diagram that indicates another example of a project page displayed by the terminal device 3 shown in FIG. 1;

FIG. 7 shows a diagram that indicates an example of a design frame displayed by the terminal device 3 shown in FIG. 1;

FIG. 8 shows a diagram that explains grouping and a layer structure of a design project by a group in Embodiment 2;

FIG. 9 shows a diagram that indicates an example of a list screen that includes a project list and the like displayed by the terminal device 3 in Embodiment 2;

FIG. 10 shows a diagram that indicates an example of a new group registration screen in Embodiment 2;

FIG. 11 shows a diagram that indicates an example of a list screen after registering a new group in Embodiment 2;

FIG. 12 shows a diagram that indicates an example of a list screen that includes a design project and a group registered for the new group in Embodiment 2;

FIG. 13 shows a diagram that indicates an example of a project timeline in Embodiment 3; and

FIG. 14 shows a diagram that indicates an example of a project timeline filtered with a specific work type in Embodiment 3.

### DETAILED DESCRIPTION

Hereinafter, embodiments according to an aspect of the present disclose will be explained with reference to drawings.

### Embodiment 1

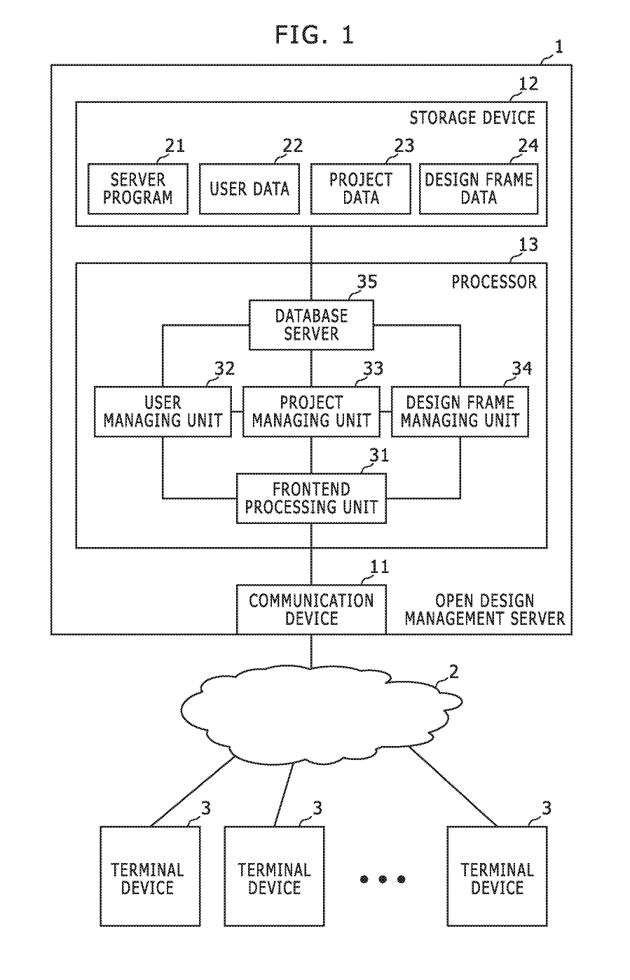

FIG. 1 shows a block diagram that indicates a configuration of an open design management server according to embodiments of the present disclosure. The open design management server 1 shown in FIG. 1 is connected to a network 2 and performs data communication with plural terminal devices 3 connected to the network 2. The network 2 is a WAN (Wide Area Network) such as Internet, a LAN (Local Area Network) and/or the like. The terminal device 3 is a terminal device such as a personal computer operated by a user who participates in a design forum of open design. In this embodiment, the terminal device 3 includes a display device such as a liquid crystal display that displays sorts of screens, and an input device such as a mouse or a keyboard, and is capable of executing a web browser.

It should be noted that users who can participate in the design forum of open design include not only a specified user who has been registered in the open design management server 1 but an unspecified user who has not been registered in the open design management server 1. Further, a user who can participate in the design forum of open design is not limited to a specialist such as a designer who makes design in a specific field.

The open design management server 1 shown in FIG. 1 includes a communication device 11, a storage device 12, and a processor 13.

The communication device 11 is a device such as a network interface capable of connecting to the network 2.

The storage device 12 is a non-volatile storage device such as a hard disk drive, an SSD (Solid State Drive), a disk array or the like. The processor 13 includes a computer that has a CPU (Central Processing Unit), a ROM (Read Only Memory), a RAM (Random Access Memory) and the like, loads sorts of programs to the RAM and executes the programs, and thereby acts as sorts of processing units.

In the storage device 12, a server program 21 is stored. Further, in the storage device 12, user data 22, project data 23, and design frame data 24 are stored. The user data 22 includes attribute information on a specified user who participates in the design forum of open design (e.g. a user name, a user type such as general public person or designer, and the like). The project data 23 includes information on a project created for each design demand posted as mentioned below. The design frame data 24 includes information on a design frame created for a proposal of a design concept posted for a design demand included in the project data 23 (i.e. a posted design demand).

The processor 13 executes the server program 21 and thereby acts as a frontend processing unit 31, a user managing unit 32, a project managing unit 33, a design frame managing unit 34, and a database server 35.

The frontend processing unit 31 performs data communication according to a predetermined protocol with the terminal device 3 using the communication device 11, and receives a post and a request transmitted from the plural terminal devices 3 operated by plural users.

In this embodiment, for example, the terminal device 3 includes a web browser, and accesses the open design management server 1 using the web browser, and in the open design management server 1, the frontend processing unit 31 includes a web server, transmits screen data according to HTTP (Hyper Text Transfer Protocol) to the accessing terminal device 3 and causes the terminal device 3 to display a screen based on the screen data. Here the screen data is described in HTML (HyperText Markup Language) or the like. Further, when detecting a user operation to the screen, the terminal device 3 transmits a post, a request or the like based on the user operation to the frontend processing unit 31 using the web browser.

When the frontend processing unit 31 receives a user registration request and attribute information on a user to be registered from the terminal device 3, the user managing unit 32 registers this user to the user data 22 on the basis of the received attribute information. Further, when the frontend processing unit 31 receives a login request from the terminal device 3, the user managing unit 32 performs a login process for a user of the terminal device 3, generates screen data of a top page (including a posting history of this user or the like) unique to the user, and transmits the screen data to this terminal device 3 using the frontend processing unit 31. Consequently, in this terminal device 3, the top page of the user is displayed. Further, a user name (e.g. user ID) of the user is attached to a post performed by a user in a login state, and the post is managed so as to associate the post with the user.

The project managing unit 33 manages a design project using the database server 35 and performs a process corresponding to the received post or request for the design project.

Specifically, (a) the project managing unit 33 transmits design demand posting screen data using the frontend processing unit 31 to the terminal device 3; and when a design demand is inputted to an input field displayed on the basis of the design demand posting screen data in the terminal device 3 and a post of the design demand is received by the frontend processing unit 31 from the terminal device 3, the project managing unit 33 creates a design project for this design demand in the database using the database server 35.

Further, (b) the project managing unit 33 transmits proposal posting screen data of a solution for the design demand using the frontend processing unit 31 to the terminal device 3; and when a proposal of a design concept is inputted to an input field displayed on the basis of the proposal posting screen data in the terminal device 3, and a post of the proposal is received by the frontend processing unit 31 from the terminal device 3, the project managing unit 33 stores the proposal in the database using the database server 35 so as to associate the proposal with the design demand. If plural proposals of design concepts are received for a single design demand, then the plural proposals are stored so as to associate the plural proposals with the single design demand.

Furthermore, (c) the project managing unit 33 transmits screen data of a project page to the terminal device 3 using the frontend processing unit 31, and the project page includes a proposal list; and when from the terminal device 3 the frontend processing unit 31 receives a creation request of a design frame for the proposal selected from the proposal list in the project page, the project managing unit 33 creates a design frame in the database using the database server 35, and stores the created design frame so as to associate the design frame with the proposal. The design frame is capable of describing a series of design work (e.g. determining a concept, determining a requirement, determining a required specification, and designing) materializing the design demand in accordance with the proposal. If plural design frames are created for a single proposal of a design concept, then the plural design frames are stored so as to associate the plural design frames with the single proposal.

Posting a design demand may be allowed to only a specified user (i.e. registered user) or may be allowed to both a specified user (i.e. registered user) and an unspecified user (i.e. guest user). Further, posting a proposal of a design concept may be allowed to only a specified user (i.e. registered user) or may be allowed to both a specified user (i.e. registered user) and an unspecified user (i.e. guest user). It should be noted that the frontend processing unit 31 receives the creation request of the design frame from the terminal device 3 of another specific type user (e.g. a designer or the like) than a user who posted the corresponding design demand.

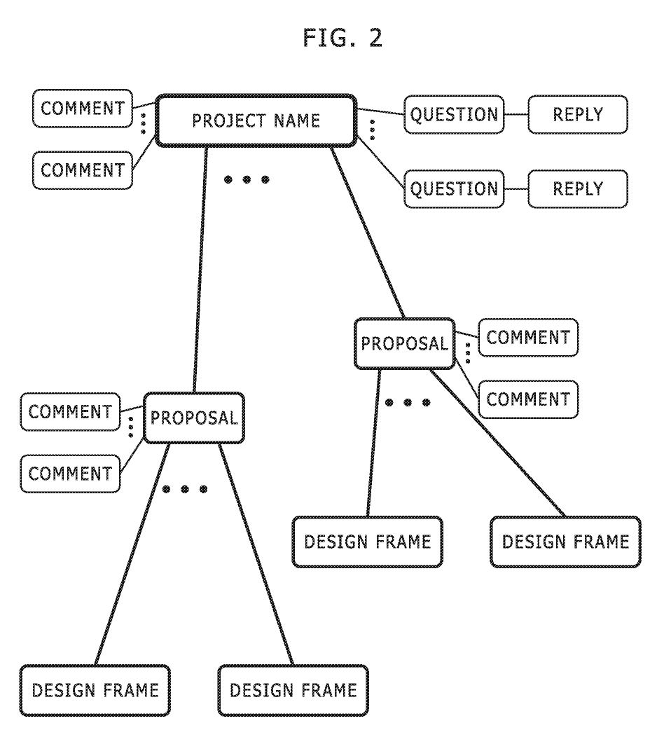

FIG. 2 shows a diagram that explains a data structure of a relational database managed by the open design management server 1 shown in FIG. 1. As shown in FIG. 2, in the database, a record of a design project is firstly created on the basis of a post of a design demand by a user received from the terminal device 3, and the design demand is stored as a project name so as to associate the design demand with the record of the design project, and afterward, a proposal of a design concept is stored on the basis of a post of the proposal by a user received from the terminal device 3 so as to associate the proposal with the design demand, and further afterward, a design frame is created and stored on the basis of a request by a user received from the terminal device 3 so as to associate the design frame with the proposal.

Further, in the database, a question related to the project name is stored on the basis of a post by a user received from the terminal device 3, and a reply to the question is stored on the basis of a post by a user received from the terminal device 3. Furthermore, in the database, a comment to the project name is stored on the basis of a post by a user received from the terminal device 3. Furthermore, in the database, a reply to the proposal is stored on the basis of a post by a user received from the terminal device 3.

Furthermore, (d) when the frontend processing unit 31 receives a browse request of a design project from the terminal device 3, regarding the design demand of the design project specified by the browse request, the project managing unit 33 identifies a relationship between the design demand and the proposal associated with each other in the database, and a relationship between the proposal and the design frame associated with each other in the database, and transmits screen data (here screen data of a project page) to the terminal device 3 for displaying the identified relationships and thereby causes the terminal device 3 to display the identified relationships.

Using the design frame data 24, the design frame managing unit 34 manages the design frame created by the project managing unit 33.

When the frontend processing unit 31 receives a browse request of a design frame from the terminal device 3, the design frame managing unit 34 reads a design frame specified by the browse request from the design frame data 24 using the database server 35, and transmits screen data for displaying this design frame to this terminal device 3 and thereby causes the terminal device 3 to display this design frame. The screen data transmitted from the project managing unit 33 or the design frame managing unit 34 to the terminal device 3 is transmitted by the frontend processing unit 31.

When a user selects any design work in the displayed design frame and inputs data such as details of work for the selected design work, the terminal device 3 transmits the inputted data as a post of the design work to the open design management server 1 using the web browser.

Subsequently, in the open design management server 1, when the frontend processing unit 31 receives the post of the design work, the design frame managing unit 34 stores the received post of the design work as a part of the design frame data 24 so as to associate the received post with the design work in the database using the database server 35.

The database server 35 receives sorts of requests according to a protocol such as SQL, and performs a database operation of the user data 22, the project data 23 and/or the like in accordance with the received request.

The following part explains a behavior of the open design management server 1 in this embodiment.

(a) User Registration and Logging In

When a user operates the terminal device 3 and thereby accesses a web page of a user registration screen of the open design management server 1, in the open design management server 1, the frontend processing unit 31 transmits screen data of the user registration screen to this terminal device 3. The terminal device 3 receives the screen data using a web browser, and displays the user registration screen based on the screen data.

When the user operates the terminal device 3 and thereby inputs user's own attribute information and password to the user registration screen, the terminal device 3 transmits a user registration request with the attribute information and the password to the open design management server 1. In the open design management server 1, the frontend processing unit 31 receives the request, the attribute information and the password, and the user managing unit 32 registers the received user's attribute information and password to the user data 22 using the database server 35.

Meanwhile, when a user operates the terminal device 3 and thereby accesses a top page (i.e. home page) of the open design management server 1 using the web browser, in the open design management server 1, the frontend processing unit 31 transmits screen data of the top page for a guest user to this terminal device 3. The terminal device 3 receives the screen data using the web browser, and displays the top page for a guest user.

Afterward, if the user has been registered in the user data 22, the user can login the open design management server 1 and thereby cause to display a top page for a registered user that includes a posting history of this user. When the user operates the terminal device 3 and thereby accesses a predetermined web page of the open design management server 1, in the open design management server 1, the frontend processing unit 31 transmits screen data of a user login screen to this terminal device 3. The terminal device 3 receives the screen data by the web browser, and displays the user login screen.

When the user operates the terminal device 3 and thereby inputs user's own user name and password, the terminal device 3 transmits a user login request with the user name and the password to the open design management server 1. In the open design management server 1, when the frontend processing unit 31 receives the request, the user name and the password, the user managing unit 32 performs a login process that performs user authentication based on the received user name and password and thereby determines whether the login is allowed or not using the database server 35. After the login is allowed, the frontend processing unit 31 generates screen data of the top page unique to the user, and transmits the generated screen data to this terminal device 3 using the frontend processing unit 31. Consequently, in this terminal device 3, the top page of the user is displayed.

Afterward, until the user logs out, in the open design management server 1, a post, a request or the like transmitted from the terminal device 3 is considered as one performed by this user in a login state.

(b) Posting a Design Demand

For example, the aforementioned top page includes a soft key for posting a design demand, and when a user operates the terminal device 3 and thereby presses down the soft key, the terminal device 3 transmits a transmission request of design demand posting screen data to the open design management server 1. In the open design management server 1, when the frontend processing unit 31 receives the request, the frontend processing unit 31 transmits the design demand posting screen data to this terminal device 3.

The terminal device 3 receives the screen data using the web browser, and displays a design demand posting page based on the screen data. The design demand posting page includes an input field of a design demand (i.e. a project name), an input field of a description text of the design demand, and an input field of a file path of an attached file to be uploaded. It should be noted that the design demand and the description text are inputted as a free text (i.e. a text that is not fixed and that a user freely composes) and are identified as text data.

When the user operates the terminal device 3 and thereby inputs the design demand and the description text (and the file path of the attached file if necessary), the terminal device 3 transmits the design demand and the description text (and the attached file if necessary) as a post of a design demand to the open design management server 1. In the open design management server 1, when the frontend processing unit 31 receives the post of the design demand, the project managing unit 33 adds a record of a design project to the project data 23 using the database server 35. In this record of the design project, the design demand is set as a project name. Here a user name of a user who posted the description text of the design demand and the design demand is added to the project data 23 so as to associate the user name with the design demand.

It should be noted that posting a design demand by a guest user with no user registration may be prohibited by not displaying a soft key for posting a design demand in the aforementioned top page for a guest user.

(c) Displaying a Design Project and Posting a Proposal of a Design Concept for a Design Demand

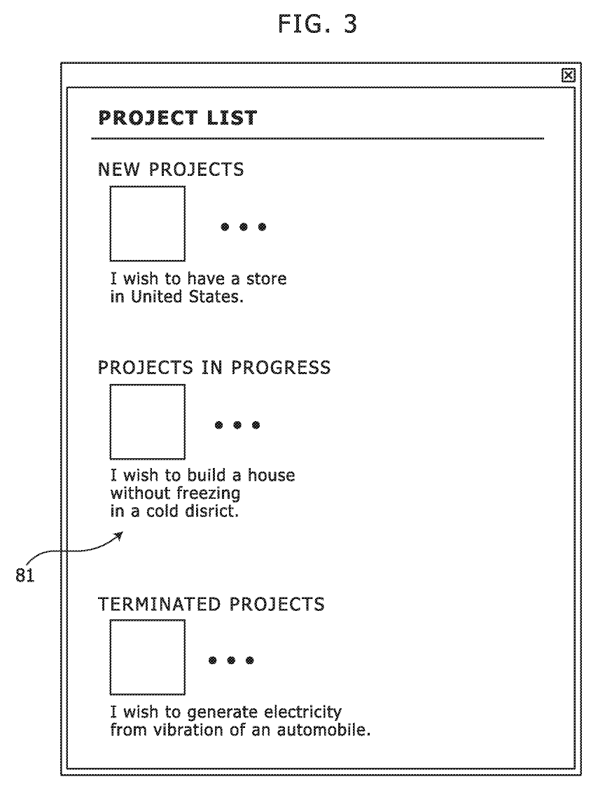

For example, the aforementioned top page includes a soft key for displaying a project list, and when a user operates the terminal device 3 and thereby presses down the soft key, the terminal device 3 transmits a transmission request of a project list to the open design management server 1. In the open design management server 1, when the frontend processing unit 31 receives the request, the project managing unit 33 identifies one or more design projects registered to the database, i.e. one or more design projects included in the project data 23, and generates a list of the identified design project(s), and the frontend processing unit 31 transmits screen data to this terminal device 3 for displaying the generated project list. The terminal device 3 receives the screen data using the web browser, and displays the project list based on the screen data. FIG. 3 shows a diagram that indicates an example of a project list displayed by the terminal device 3 shown in FIG. 1. For example, as shown in FIG. 3, a clickable icon (e.g. a rectangle in FIG. 3) is displayed corresponding to each design project included in the project list.

When a user operates the terminal device 3 and thereby selects one project in the project list, using the web browser, the terminal device 3 transmits to the open design management server 1 a transmission request of screen data for displaying the selected project. In the open design management server 1, when the frontend processing unit 31 receives the request, the project managing unit 33 reads a design demand and the like of the project specified by the request from the project data 23 using the database server 35, and generates screen data for displaying a project page that includes the read design demand and the like, and the frontend processing unit 31 transmits the generated screen data to this terminal device 3. The terminal device 3 receives the screen data using the web browser, and displays the project page based on the screen data.

The project page includes (a) a design demand of the design project and (b) data (a comment, a question, a proposal of a design concept or the like) associated with the design demand in the database, and further includes (c) data associated with a proposal of a design concept associated with the design demand, (d) whether a design frame has been created for a proposal of a design concept associated with the design demand or not, (e) the number of design frames created for a proposal of a design concept associated with the design demand, and/or the like.

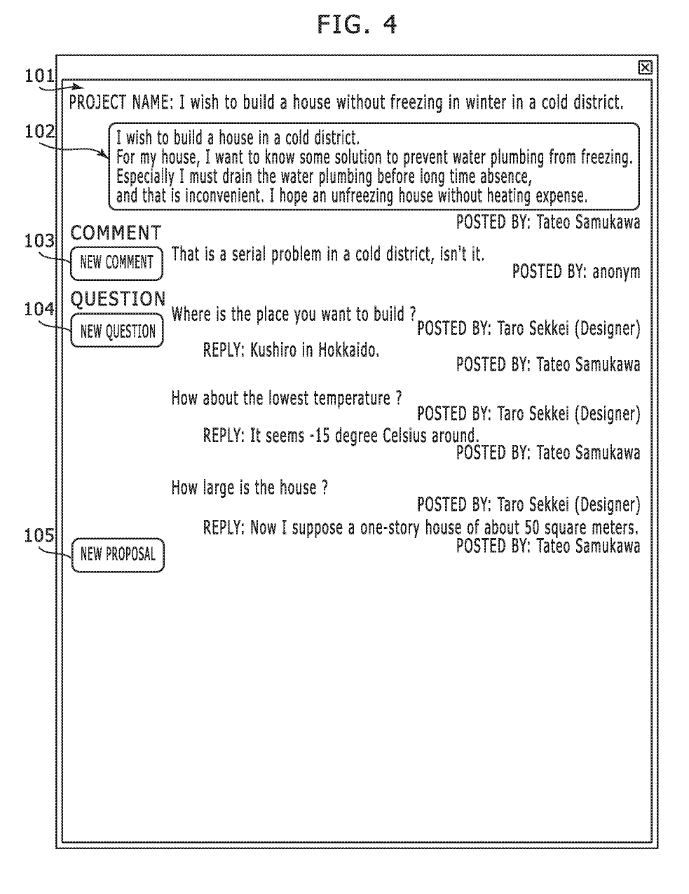

FIG. 4 shows a diagram that indicates an example of a project page displayed by the terminal device 3 shown in FIG. 1.

For example, if a design project 81 is selected in FIG. 3, then as shown in FIG. 4, the project page includes a project name (i.e. design demand) 101, a description text 102, a new comment key 103 for posting a comment to the design demand, a new question key 104 for posting a question to the design demand, and a new proposal key 105 for posting a proposal of a design concept to the design demand.

If a user operates the terminal device 3 and thereby presses down the new comment key 103, causes the terminal device 3 to display an input field, and inputs a comment (i.e. a free text) to the input field, then the terminal device 3 transmits a post of the comment associated with the design demand to the open design management server 1. In the open design management server 1, when the frontend processing unit 31 receives the post, the project managing unit 33 adds the comment to the project data 23 so as to associate the comment with the design demand using the database server 35.

If a user operates the terminal device 3 and thereby presses down the new question key 104, causes the terminal device 3 to display an input field, and inputs a question (i.e. a free text) to the input field, then the terminal device 3 transmits a post of the question associated with the design demand to the open design management server 1. In the open design management server 1, when the frontend processing unit 31 receives the post, the project managing unit 33 adds the question to the project data 23 so as to associate the question with the design demand using the database server 35.

If a user operates the terminal device 3 and thereby presses down the new proposal key 105, causes the terminal device 3 to display an input field, then the terminal device 3 transmits a transmission request of proposal posting screen data to the open design management server 1. In the open design management server 1, when the frontend processing unit 31 receives the request, and transmits the proposal posting screen data to this terminal device 3. The terminal device 3 receives the screen data using the web browser and displays a proposal posting page based on the screen data. The proposal posting page includes an input field of a proposal of a design concept, an input field of a file path of an attached file to be uploaded. The proposal is inputted as a free text and identified as text data.

When the user operates the terminal device 3 and thereby to the proposal posting page, inputs a proposal of a design concept (and a file path of an attached file if necessary), the terminal device 3 transmits a post of the inputted proposal (and the attached file if necessary) associated with the design demand to the open design management server 1 using the web browser. In the open design management server 1, when the frontend processing unit 31 receives the post of the proposal, the project managing unit 33 adds the proposal to the project data 23 so as to associate the proposal with the design demand using the database server 35.

It should be noted that the project page shown in FIG. 4 includes a comment, a question and a reply to the question that were posted. The reply to the question can be posted only by a user who posted the design demand. For example, if a user who posted a design demand causes the terminal device 3 to display a project page, then a reply key is arranged for each question in the project page, and when the user operates the terminal device 3 and thereby presses down the reply key and inputs a reply to the question, the terminal device 3 transmits a post of the reply associated with the corresponding question to the open design management server 1 using the web browser. In the open design management server 1, when the frontend processing unit 31 receives the post, the project managing unit 33 adds the reply to the project data 23 so as to associate the reply with the question using the database server 35.

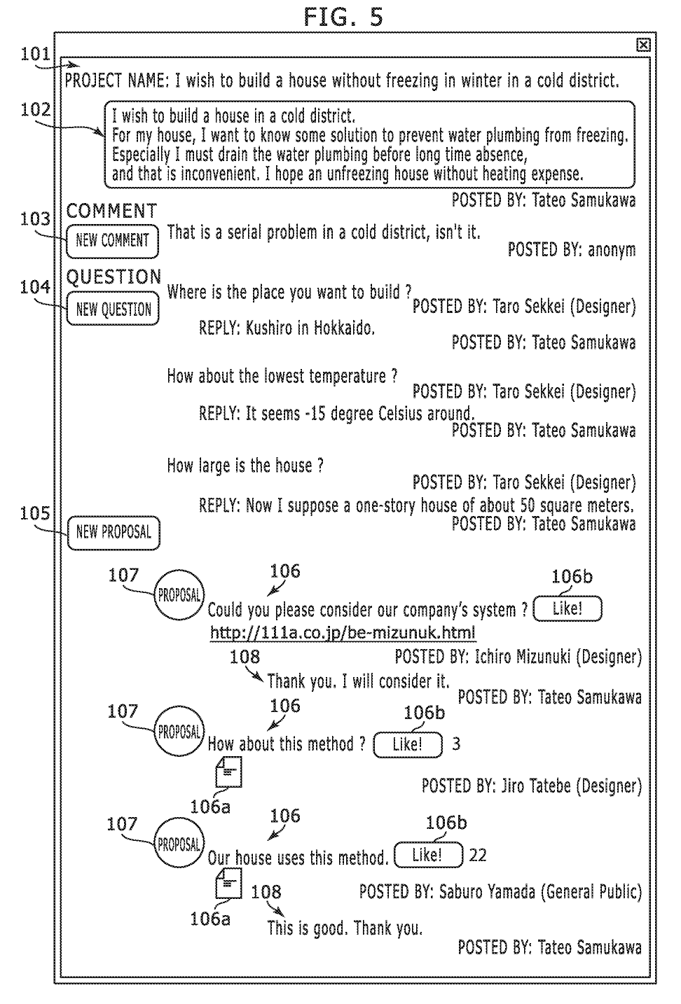

FIG. 5 shows a diagram that indicates another example of a project page displayed by the terminal device 3 shown in FIG. 1. For example, if three proposals of design concepts are posted in turn in a situation shown in FIG. 4, then a project page shown in FIG. 5 is displayed. The project page shown in FIG. 5 includes three proposals 106 and three soft keys 107, and the soft keys 107 are assigned to the proposals 106, respectively. If an attached file is attached to the proposal 106, an icon 106a is arranged with the proposal 106, and the icon 106a includes a link to the attached file. In addition, in the proposal, an HTML tag may be enabled to be used. Thus, for example, as shown in FIG. 5, the proposal can include a link to a web page that indicates details of the proposal.

In addition, with each one of the proposals 106, a “Like!” key 106b is arranged, and the number of users who pressed down the “Like!” key 106b is arranged next to the “Like!” key 106b. When the “Like!” key 106b is pressed down, pressing-down information is transmitted to the open design management server 1. The pressing-down information indicates the proposal 106 corresponding to the pressed-down key 106b and a user name of a user who pressed down this key 106b. In the open design management server 1, the frontend processing unit 31 receives the pressing-down information, the project managing unit 33 updates the number of users who pressed down the key 106b corresponding to this proposal 106.

The soft key 107 is a soft key for creating a design frame for a proposal of a design concept corresponding to this soft key 107.

The project page shown in FIG. 5 also includes a reply 108 to the proposal 106. A reply to the proposal 106 can be posted only by a user who posted the design demand. For example, if a user who posted a design demand causes the terminal device 3 to display a project page, then a reply key is arranged for each proposal 106 in the project page, and when the user operates the terminal device 3 and thereby presses down the reply key and inputs a reply to the question, the terminal device 3 transmits a post of the reply associated with the corresponding proposal 106 to the open design management server 1 using the web browser. In the open design management server 1, when the frontend processing unit 31 receives the post, the project managing unit 33 adds the reply to the project data 23 so as to associate the reply with the proposal using the database server 35.

(d) Creating a Design Frame for a Proposal of a Design Concept

When a user wants to create a design frame for making design work proceed for the displayed proposal 106, the user operates the terminal device 3 and thereby presses down the soft key 107 corresponding to this proposal 106. It should be noted that the user who creates a design frame is a specialist such as a designer who well understands a method and a knowledge of a concrete design process.

When detecting a user operation to press down the soft key 107, the terminal device 3 transmits a creation request of a design frame to the open design management server 1 using the web browser. This creation request is a request for creating a design frame associated with the proposal 106 corresponding to this soft key 107.

In the open design management server 1, when the frontend processing unit 31 receives the request, the project managing unit 33 adds a new design frame to the design frame data 24 using the database server 35 so as to associate the new design frame with the proposal.

A user who is allowed to create a design frame may be limited to only a specific type user such as designer in the user data 22. In such a case, for example, if a creation request of a design frame is performed by a user other than a specific type user identified by the user data 22, then the project managing unit 33 denies the creation request.

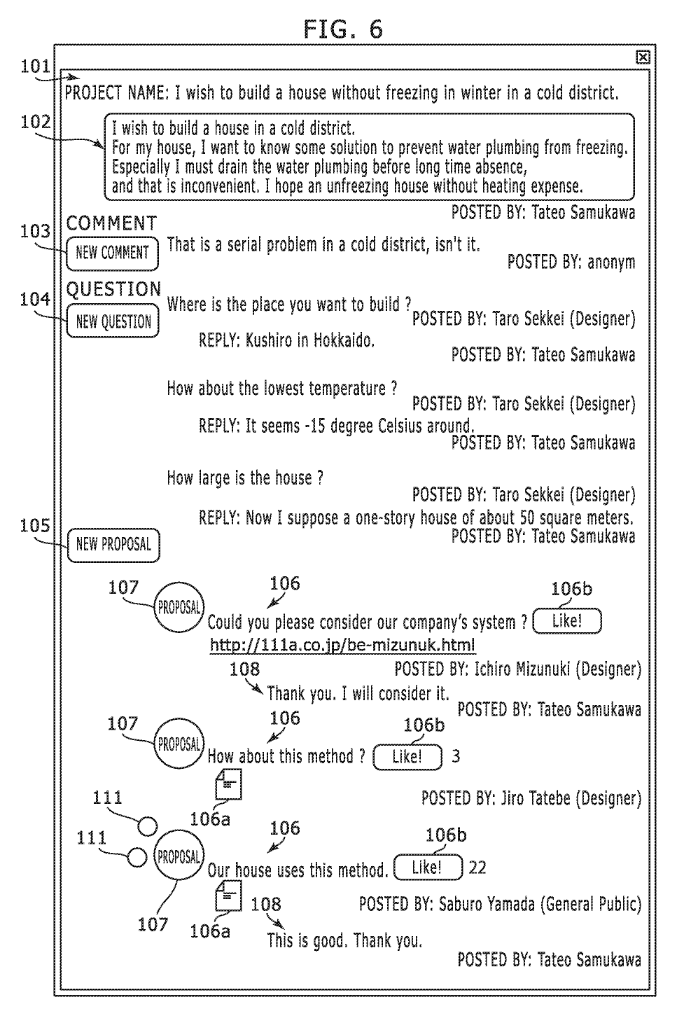

FIG. 6 shows a diagram that indicates another example of a project page displayed by the terminal device 3 shown in FIG. 1. As shown in FIG. 6, in order to clearly indicate that a design frame has been created for the proposal 106, one or plural icons 111 corresponding to one or plural design frames respectively is/are arranged in a peripheral area of a figure of the soft key 107 so as to associate the one or plural icons 111 with the proposal 106 and the soft key 107.

In an example shown in FIG. 6, two design frames are created for one of the three proposals 106, and therefore two icons 111 are arranged corresponding to these design frames, respectively.

The project managing unit 33 may select an image of the icon 111 corresponding to a status or progress of design work in a design frame, and may generate the screen data of the project page to display the icon 111 with the selected image. For example, among plural images that indicate the waxing and waning of the moon, an image of a moon phase corresponding to a status or progress of design work is selected as the image of the icon 111.

According to this icon 111, the user visually finds out (a) that a design frame has been created for the proposal 106 and specific design work is in progress, and (b) the number of design frames created for the proposal 106.

As mentioned, if plural proposals of design concepts are associated with one design demand in the database, the project managing unit 33 of the open design management server 1 transmits screen data to the terminal device 3, as shown in FIGS. 5 and 6, for displaying, in one screen, relationships between the design demand and the proposals associated with each other in the database using the frontend processing unit 31 and causes the terminal device 3 to display the relationships between the design demand and the plural proposals in one screen.

Further, if plural design frames are associated with one proposal of a design concept in the database, the project managing unit 33 of the open design management server 1 transmits screen data to the terminal device 3 for displaying, in one screen, relationships between the proposal and the design frames associated with each other in the database using the frontend processing unit 31 and causes the terminal device 3 to display the relationships between the proposal and the plural design frames in one screen. For example, as shown in FIG. 6, the relationship between the proposal and the design frame is expressed as a relationship between the icon 111 and at least one of the proposal 106 and the soft key 107.

Furthermore, the project managing unit 33 may transmit screen data to the terminal device 3 using the frontend processing unit 31 for displaying a relationship between the proposal and the design frame associated with each other in the database and also displaying a status and/or progress of the design work in the design frame, and may cause the terminal device 3 to display the status and/or the progress of the design work with the relationship between the proposal and the design frame.

(f) Displaying a Design Frame

A user operates the terminal device 3 and thereby presses down the icon 111 in the project page, and consequently the user can browse a design frame corresponding to the icon 111.

When detecting a user operation to press down the icon 111, the terminal device transmits a transmission request of screen data of a design frame corresponding to the icon 111 to the open design management server 1 using the web browser. In the open design management server 1, when the frontend processing unit 31 receives the request, the design frame managing unit 34 reads a design frame corresponding to the icon 111 from the design frame data 24 using the database server 35, generates screen data of the read design frame, and transmits the generated screen data to this terminal device 3 using the frontend processing unit 31. The terminal device 3 receives the screen data using the web browser, and displays the design frame based on the screen data.

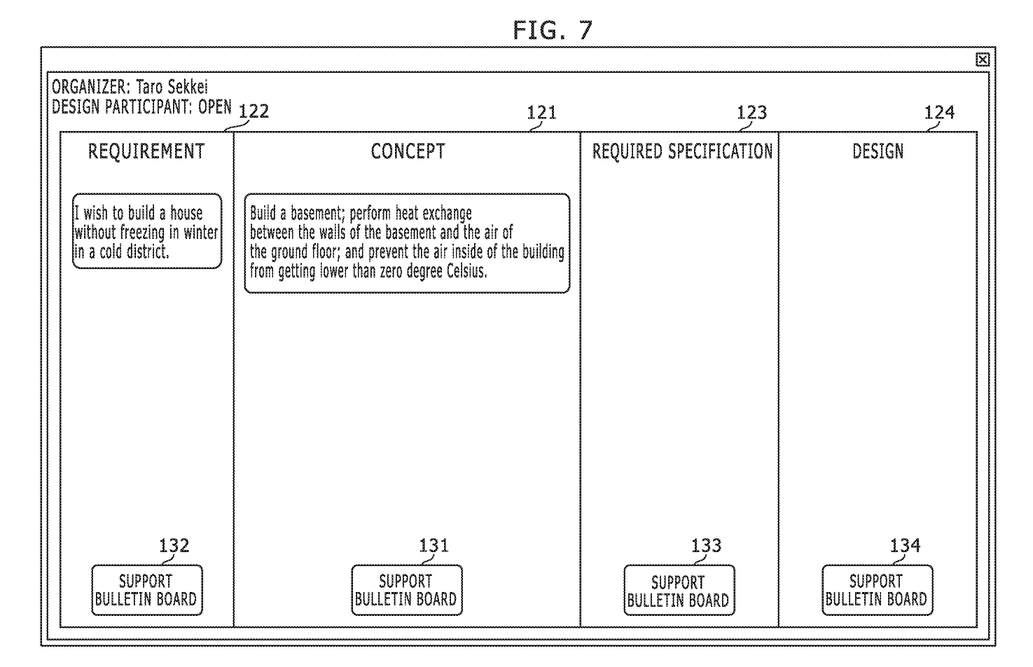

FIG. 7 shows a diagram that indicates an example of a design frame displayed by the terminal device 3 shown in FIG. 1. As shown in FIG. 7, in this embodiment, design work in the design frame includes determining a concept, determining a requirement, determining a required specification, and concrete designing (e.g. creating design drawing). In determining a concept, determining a requirement or determining required specification, for example, by a user, a matter to be determined is broken down from an outline to details. The design frame includes a requirement part, a concept part, a required specification part, and a design part. The requirement part includes (a) receiving and displaying a post of requirement, (b) receiving and displaying a post of an evaluation of the posted requirement, and (c) an electronic bulletin board of a comment. The concept part includes (a) receiving and displaying a post of design concept, (b) receiving and displaying a post of an evaluation of the posted design concept, and (c) an electronic bulletin board of a comment. The required specification part includes (a) receiving and displaying a post of required specification, (b) receiving and displaying a post of an evaluation of the posted required specification, and (c) an electronic bulletin board of a comment. The design part includes (a) receiving and displaying a post of detailed design, (b) receiving and displaying a post of an evaluation of the posted detailed design, and (c) an electronic bulletin board of a comment.

Further, by a user who created a design frame (hereinafter called “organizer”), regarding each part of design work in the design frame, a work detail or a work outcome is inputted in the terminal device 3. The inputted work detail or work outcome is added to the design frame data 24 so as to associate the inputted work detail or work outcome with design work of the design frame.

In addition, the organizer can set a range of users allowed to participate in design work of the design frame. If the organizer enables only a specific user to participate in design work of the design frame, then the organizer selects the CLOSED mode, and selects a user allowed to participate. Contrarily, if the organizer enables all users to participate in design work of the design frame, then the organizer selects the OPEN mode.

For example, the screen data of the project page is configured so as to display a dialog for the organizer to select a participant mode (i.e. CLOSED mode or OPEN mode) when detecting a user operation to the icon 111 for creating a design frame; and when in the dialog the user (i.e. the organizer) selects the participant mode (and a user name of a user allowed to participate if the CLOSED mode is selected), the terminal device 3 transmits the selected participant mode (and the user name of the participant if necessary) with a creation request of a design frame to the open design management server 1 using the web browser. In the open design management server 1, when the frontend processing unit 31 receives the request and the like, the project managing unit 33 adds the participant mode as attribute information of the design frame to the design frame data 24 so as to associate the participant mode with the design frame using the database server 35 when adding this design frame to the design frame data 24.

In the OPEN mode, all users can browse the design frame corresponding to the icon 111 by pressing down the icon 111 in the project page, and can participate in the design work.

Contrarily, in the CLOSED mode, when a user presses down the icon 111 in the project page, only a user allowed to participate can browse the design frame corresponding to the icon 111 and can participate in the design work.

Specifically, when a user presses down an icon 111, the frontend processing unit 31 of the open design management server 1 receives a transmission request of screen data of a design frame corresponding to this icon 111, and upon receiving the transmission request, the design frame managing unit 34 refers to the design frame data 24 using the database server 35, and thereby identifies the participant mode of the design frame corresponding to this icon 111.

If the identified participant mode is the OPEN mode, then the design frame managing unit 34 reads the design frame corresponding to the icon 111 from the design frame data 24 using the database server 35, generates screen data of the read design frame, and transmits the generated screen data to the terminal device 3 using the frontend processing unit 31. The terminal device 3 receives the screen data using the web browser, and displays the design frame based on the screen data.

Contrarily if the identified participant mode is the CLOSE mode, then the design frame managing unit 34 determines whether the user who transmitted the transmission request is a user allowed to participate in the design frame or not on the basis of the design frame data 24. If the user who transmitted the transmission request is a user allowed to participate in the design frame, then the design frame managing unit 34 reads the design frame corresponding to the icon 111 from the design frame data 24 using the database server 35, generates screen data of the read design frame, and transmits the generated screen data to the terminal device 3 using the frontend processing unit 31. The terminal device 3 receives the screen data using the web browser, and displays the design frame based on the screen data. Contrarily, if the user who transmitted the transmission request is not a user allowed to participate in the design frame, then the design frame managing unit 34 denies the transmission request and does not transmit the screen data of the design frame. Therefore, in this case, the design frame is not displayed in the terminal device 3.

It should be noted that an invitation may be issued to a user who is allowed to participate by the organizer. This invitation, for example, is displayed on a top page of the user who is allowed to participate by the organizer.

After starting to display a design frame, for example, when a user operates the terminal device 3 and thereby presses down a field 121, 122, 123 or 124 of design work in the design frame, causes the terminal device to display an input field, and inputs a comment (i.e. a free text) or a file path of an attached file to the input field, the terminal device 3 transmits a post of the comment and/or the attached file associated with design work of the design frame to the open design management server 1. In the open design management server 1, when the frontend processing unit 31 receives the post and/or the attached file, the design frame managing unit 34 adds the post and/or the attached file to the design frame data 24 so as to associate the post and/or the attached file with the design work of the design frame using the database server 35. The screen data of the design frame includes a comment added in this manner and/or an icon that includes a link to an attached file added in this manner, and such comment and/or icon is/are displayed in the area 121, 122, 123 or 124 of the design work in the design frame.

When creating a design frame, a corresponding proposal 106 may be automatically added as a comment of “determining a concept” (i.e. “CONCEPT” in FIG. 7) as design work of the design frame. Further, when creating a design frame, a corresponding design demand may be automatically added as a comment of “determining a requirement” (i.e. “REQUIREMENT” in FIG. 7) as design work of the design frame.

Furthermore, support bulletin board keys 131 to 134 are arranged for the areas 121 to 124 of design work of the design frame, respectively, and when a user operates the terminal device 3 and thereby presses down the support bulletin board key 131, 132, 133 or 134, the terminal device 3 accesses a support bulletin board on the web corresponding to the pressed-down key using the web browser and displays the support bulletin board using the web browser. Thus a design participant can make discussion with the organizer on the support bulletin board.

As mentioned, in Embodiment 1, the project managing unit 33 (a) creates a design project for a design demand in the database when a post of the design demand is received from the terminal device 3; (b) stores a proposal of a design concept in the database so as to associate the proposal with the design demand when a post of the proposal is received from the terminal device 3, where the one or plural proposals is/are enabled to be associated with the single design demand; (c) creates a design frame in the database when a creation request of a design frame for the proposal is received from the terminal device, and stores the created design frame so as to associate the design frame with the proposal, where the design frame is capable of describing a series of design work materializing the design demand in accordance with the proposal and the one or plural design frames is/are enabled to be associated with the single proposal; and (d) transmits screen data to the terminal device 3 for displaying a relationship between the design demand and the proposal associated with each other in the database, and a relationship between the proposal and the design frame associated with each other in the database, and causes the terminal device 3 to display the relationships.

Consequently, a user who does not participate in the design work can browse information on the design work performed for materializing a proposal of a design concept posted for a design demand ((a) whether the design idea will be materialized or not, (b) a progress status of a specific design for materializing the design idea, (c) what specific design finally materialized the design idea, and the like), and thereby it is possible to improve motivation to post a design demand or a proposal of a design concept and consequently realize effective open design.

Further, the open design management server 1 of this embodiment builds a design forum of open design in which a matter to be realized (i.e. a design demand) is publicly invited to the general public, both a general public person and a specialist can make a proposal of a design concept for the design demand (i.e. a solution proposal), and plural specialists discuss a realizing method (i.e. design work) for an excellent proposal. In such a case, it may be configured that everyone can post a design demand.

Consequently, since for a design demand a solution proposal can be unqualifiedly posted by the general public and specialists, many miscellaneous solutions are proposed like brainstorming. However, among such many solutions a specialist (i.e. a person who well understands a method and a knowledge of a concrete design process) selects an excellent proposal and makes design work progress for the selected proposal, and therefore it is restrained that the discussion is widely diverged and comes to end without any outcome, and it is relatively easy for the open design to properly reach a concrete outcome (i.e. a concrete design).

It should be noted that as shown in FIGS. 4 to 6, due to its structure, in the project page, a comment to a comment cannot be posted (i.e. a post of such comment is prohibited). In addition, due to its structure, in the project page, a reply to a proposal of a design concept cannot be posted by another user than the user who posted the design demand (i.e. a post of such reply by another user the user who posted the design demand is prohibited). These manners also restrain the divergence of the discussion.

It should be noted that since plural proposals of design concepts can be posted for one design demand, another proposal of a design concept can be posted as an alternative proposal to a proposal of a design concept that has been posted. As well, since plural design frames can be created for one proposal of a design concept, another design frame can be created as an alternative design frame to a design frame that has been created. In addition, it is possible that a user posts a proposal of a partial solution to a design demand, and afterward this user or another user can post a lacking part in the partial solution to make a complete solution or can post a proposal for a whole solution (i.e. a complete solution).

### Embodiment 2

An open design management server 1 in Embodiment 2 of the present disclosure is one obtained by adding the following function to the open design management server 1 in Embodiment 1.

In Embodiment 2, the project managing unit 33 manages a group of a design project in the aforementioned database using the database server 35. The group is capable of including one or plural other groups and one or plural design projects. Therefore, setting a group enables to manage design projects in multi layers. For example, the project data 23 includes group data, and the group data includes, for each group, (a) attribute information of the group (i.e. a group name, a description text, a file path of an icon file and the like), and (b1) a project ID unique to a design project included in the group and/or (b2) a group ID of a group included in the group. Therefore, on the basis of the group data, a design project and a group included in each group are identified.

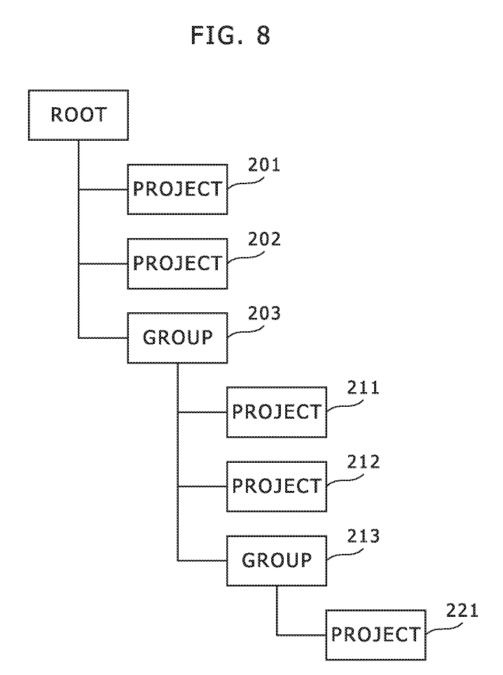

FIG. 8 shows a diagram that explains grouping and a layer structure of a design project by a group in Embodiment 2. For example, as shown in FIG. 8, if design projects 201, 202, 211, 212 and 221 and groups 203 and 213 are created, in a top screen (i.e. a top screen for displaying a list of design projects in multi layers), the design projects 201 and 202 and the group 203 in the root are displayed as a list, and the other design projects 211, 212 and 221 and the other group 213 are not displayed in the top screen. If a specific user operation (e.g. double clicking or the like) is performed to the group 203, the design project 211 and 212 and the group 213 are displayed as a list, and the other design projects 201, 202 and 221 are not displayed in the list. For example, as shown in FIG. 8, a clickable icon is displayed corresponding to each design project or group included in the list.

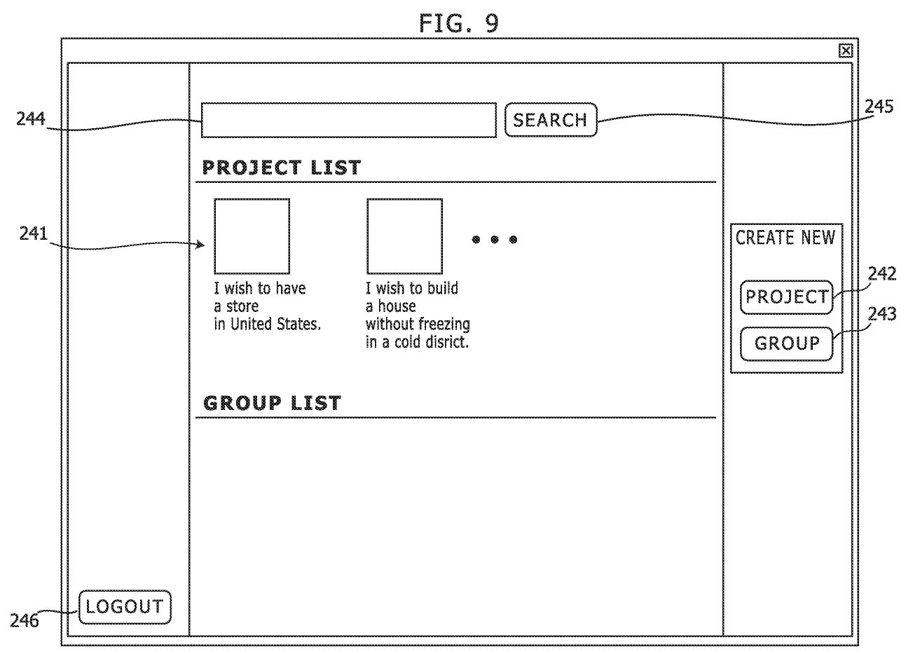

FIG. 9 shows a diagram that indicates an example of a list screen that includes a project list and the like displayed by the terminal device 3 in Embodiment 2.

As well as Embodiment 1, the top page displayed at logging in includes a soft key for displaying a project list, and when a user operates the terminal device 3 and thereby presses down the soft key, the terminal device 3 transmits a transmission request of a project list to the open design management server 1. In the open design management server 1, when the frontend processing unit 31 receives the request, the project managing unit 33 identifies a group and a design project registered in the database, i.e. a group and a design project included in the project data 23, using the database server 35, and generates a list of the identified group and the identified design project, and the frontend processing unit 31 transmits screen data for displaying the generated project list and the generated group list to the terminal device 3. The terminal device 3 receives the screen data, and displays a list screen that includes the project list and the group list based on the screen data. The group list and the project list are combined as one list.

When pressing down the soft key for displaying a project list, screen data of a top screen is firstly generated and transmitted to the terminal device 3, and a list screen as a top screen is displayed on the basis of the screen data. Consequently, for example as shown in FIG. 9, a project list 241 is displayed. In an example shown in FIG. 9, since no groups are registered, a group list is not displayed. The list screen includes a soft key 242 for creating a new project and a soft key 243 for creating a new group in the currently displayed list.

Further, the list screen includes an input field 244 for inputting a search key of a group and a project and a search execution key 245. When a user inputs a search key in the input field 244 and presses down the search execution key 245, the terminal device 3 transmits a search request and the search key to the open design management server 1 using the web browser. When the frontend processing unit 31 receives the search request and the search key, the project managing unit 33 searches groups and design projects registered in the database with the search key using the database server 35, and the frontend processing unit 31 transmits screen data for displaying a list screen to this terminal device 3. This list screen includes a list of a group and a design project found in the search. The terminal device 3 receives the screen data using the web browser, and displays the list screen based on the screen data as the search result.

Further, in the list screen, a logout key 246 is included.

On the basis of the aforementioned configuration, when a user presses down the soft key 242, the terminal device 3 transmits a transmission request of screen data of a new design project registration screen to the open design management server 1 using the web browser, and in the open design management server 1, the frontend processing unit 31 receives the request and transmits the requested screen data to the terminal device 3. The terminal device 3 receives the screen data using the web browser, and displays the new design project registration screen based on the screen data. In the new design project registration screen, when a user inputs a project name, a description text, a local file path of an icon file and the like and presses down a soft key for registering a new design project, the terminal device 3 transmits a registration request of a new design project, related information on the new design project (i.e. the project name and the like) and the icon file to the open design management server 1. In the open design management server 1, the frontend processing unit 31 receives the transmitted request and the like and registers a new project to the database on the basis of the received information.

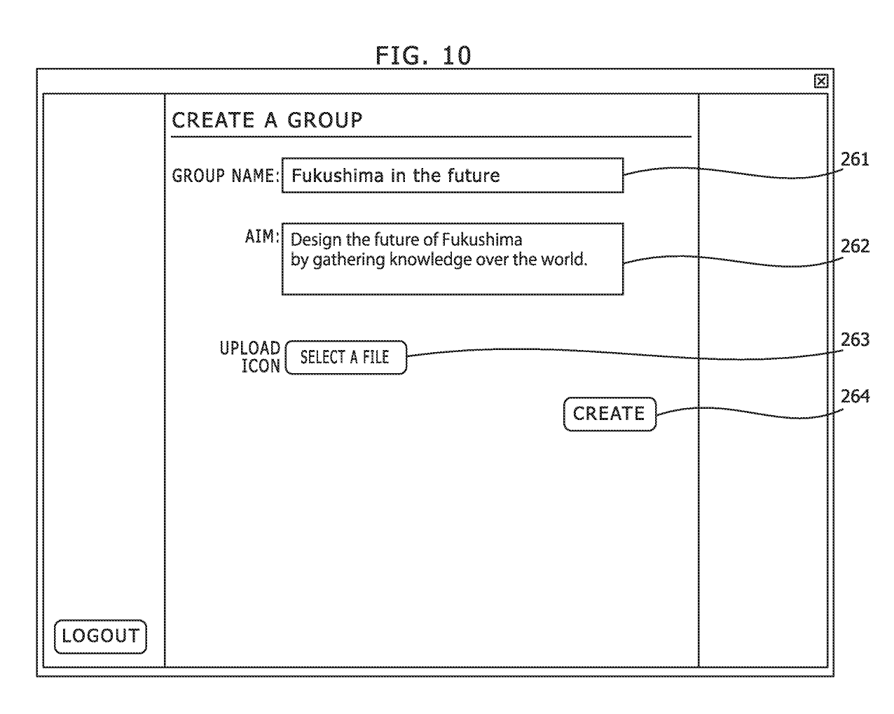

Meanwhile, when a user presses down the soft key 243, the terminal device 3 transmits a transmission request of screen data of a new group registration screen to the open design management server 1 using the web browser, and in the open design management server 1, the frontend processing unit 31 receives the request and transmits the requested screen data to the terminal device 3. The terminal device 3 receives the screen data using the web browser, and displays the new group registration screen based on the screen data. FIG. 10 shows a diagram that indicates an example of a new group registration screen in Embodiment 2.

For example, as shown in FIG. 10, the new group registration screen includes input fields 261 and 262 of a group name, a description text and the like and a soft key 263 for displaying a dialog to select an icon file, and when a user inputs a group name, a description text and the like to the input fields 261 and 262, selects an icon file if necessary, and presses down a soft key 264 for registering a new group, the terminal device 3 transmits a registration request of a new group, related information on the new group (i.e. the group name, the description text, the icon file name and the like) and the icon file to the open design management server 1. In the open design management server 1, the frontend processing unit 31 receives the transmitted request and the like and registers a new group to the database on the basis of the received information.

When completing the registration of the new design project or the new group, the frontend processing unit 31 transmits screen data of a list screen after the registration of the new design project or the new group to this terminal device 3. The terminal device 3 receives the screen data using the web browser, and updates the currently displayed list screen on the basis of the received screen data.

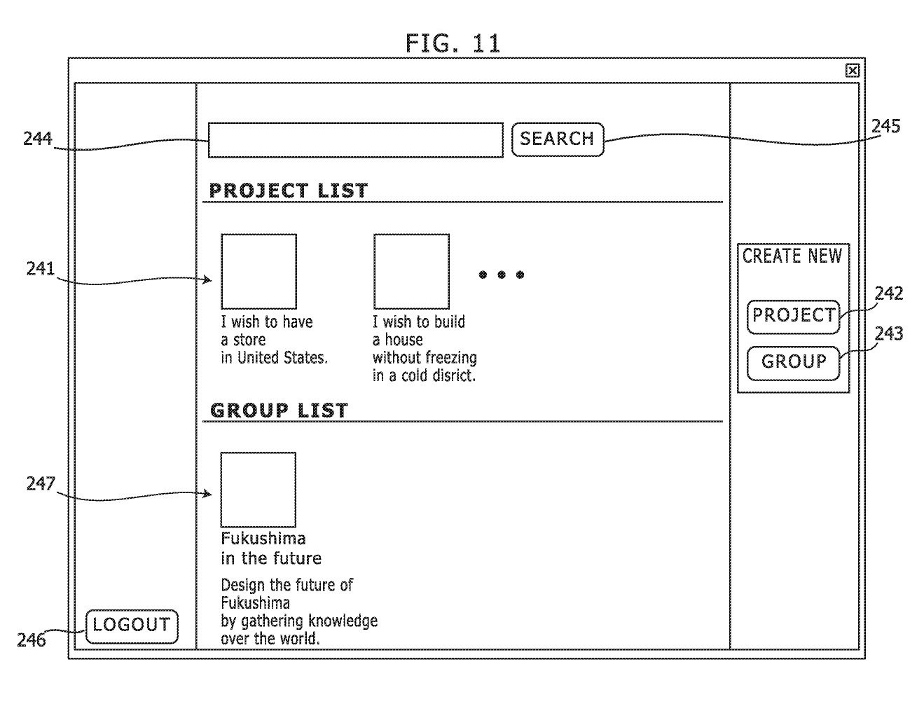

FIG. 11 shows a diagram that indicates an example of a list screen after registering a new group in Embodiment 2. For example, when registering a new group in the state of the list screen shown in FIG. 9, a group list 247 that includes a registered new group is displayed as shown in FIG. 11.

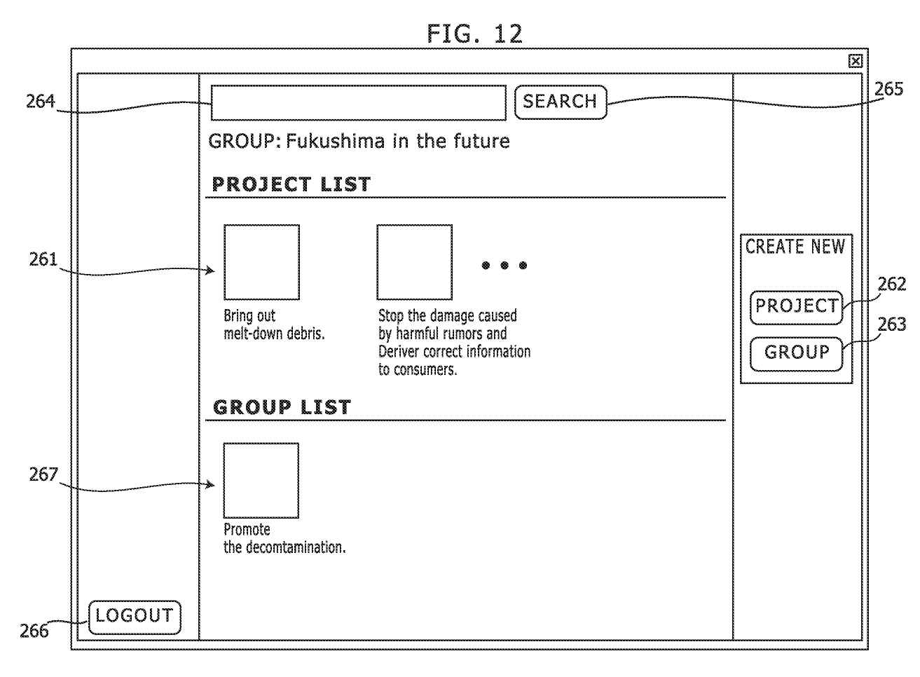

Further, as shown in FIG. 12, for the registered new group, it is possible to further register a design project and/or a group included in the new group. FIG. 12 shows a diagram that indicates an example of a list screen that includes a design project and a group registered for the new group in Embodiment 2. The list screen shown in FIG. 12 includes a list 261 and a list 267. The list 261 includes a design project included in the registered group in the list screen shown in FIG. 11, and the list 267 includes a group included in the registered group in the list screen shown in FIG. 11. The list screen shown in FIG. 12 includes not only the list 261 of the design project and the list 267 of the group but soft keys 262, 263 and 265, a logout key 266 and an input field 264 that are same as the soft keys 242, 243 and 245, the logout key 246 and the input field 244 in the top screen shown in FIGS. 9 and 11.

In FIG. 11, the design projects 201 and 202 and the group 203 shown in FIG. 8 are displayed in the list screen; and in FIG. 12, the design projects 211 and 212 and the group 213 shown in FIG. 8 are displayed in the list screen.

Further, for example, when a user operates the terminal device 3 and thereby selects a group in the list screen shown in FIG. 11, the terminal device 3 transmits a transmission request of screen data for displaying a list of design projects and groups included in the selected group to the open design management server 1 using the web browser. In the open design management server 1, when the frontend processing unit 31 receives the request, the project managing unit 33 generates screen data for displaying a list screen of the list specified by the request on the basis of the project data 23 using the database server 35, and transmits the generated screen data to this terminal device 3. The terminal device 3 receives the screen data using the web browser, and displays the list on the basis of the screen data.

The other parts of the configuration and the behavior of the open design management server 1 in Embodiment 2 are same as or similar to those in Embodiment 1, and therefore are not explained here.

As mentioned, in Embodiment 2, grouping and layer management of design projects are enabled.

### Embodiment 3

An open design management server 1 in Embodiment 3 of the present disclosure is one obtained by adding the following function to the open design management server 1 in Embodiment 1 or 2.

In Embodiment 3, when adding a post of the aforementioned design work (i.e. the aforementioned comment and the attached file) to the design frame data 24, a posting time (i.e. the date and the time when the post is received, the date and the time when the post is added or the like) is also added to the design frame data 24 so as to associate the posting time with the design work (i.e. the added post). For example, when receiving a request from the terminal device 3, the design frame managing unit 34 generates timeline data for displaying pieces (i.e. posts) of design work of a design frame so as to arrange pieces of the design work in the order of posting times of the pieces, and transmits the timeline data to the terminal device 3 using the frontend processing unit 31 and thereby, on the basis of the timeline data, causes the terminal device 3 to display the pieces of the design work arranged in the order of posting times of the pieces. Hereinafter, a list of pieces of design work arranged in the order of posting times in this manner is called “project timeline.” Thus, a project timeline includes all or a part of one or posts to a project page and one or posts to a design frame arranged in the time-series order. For example, an arrangement in the time-series order of all posts to a design frame, posts of requirement and concept in a project page or a design frame, post of required specification and design in a design frame or the like is displayed as a project timeline.

Further, the design frame managing unit 34 (a) receives from the terminal device 3 type selection information that indicates a type of design work selected by a user operation to the terminal device 3, (b) extracts pieces of design work agreed with the type indicated by the received type selection information among the design work of the design frame, (c) generates timeline data for displaying the extracted design work arranged in the order of a posting time, and (d) transmits the generated timeline data to the terminal device 3 using the frontend processing unit 31 and thereby causes the terminal device 3 to display the extracted design work arranged in the order of a posting time, namely as a project timeline. Therefore design work of a type not selected by the user is not displayed in the project timeline.

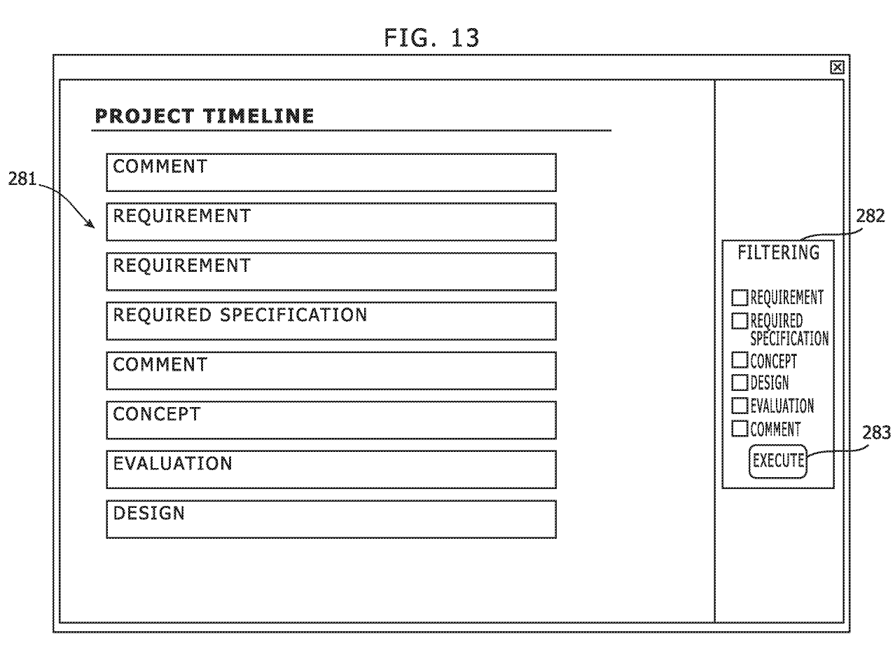

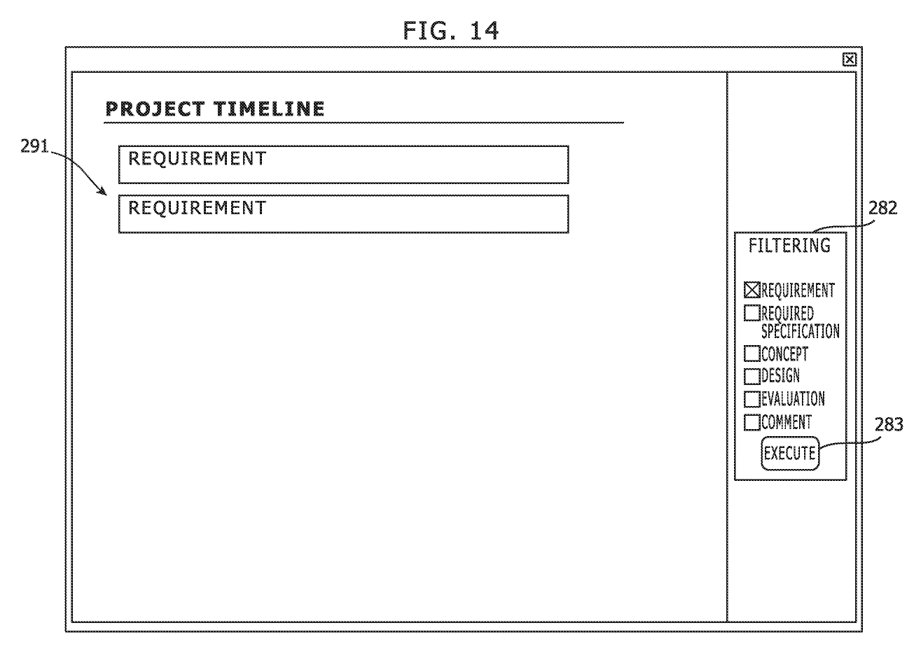

FIG. 13 shows a diagram that indicates an example of a project timeline in Embodiment 3. FIG. 14 shows a diagram that indicates an example of a project timeline filtered with a specific work type in Embodiment 3. In project timelines 281 and 291 shown in FIGS. 13 and 14, pieces of the design work are arranged so as to lay the older one higher and the newer one lower.

For example, as shown in FIG. 13, an operation member 282 is displayed with the project timeline 281 for inputting a type of design work as a filtering condition of the project timeline 281. In Embodiment 3, as the operation member 282, a design work list for selecting a type of design work, check boxes corresponding to respective types in the design work list, and an execution key 283 are displayed.

When the user checks a check box corresponding to a desired type of design work and presses down the execution key 283, the terminal device 3 transmits type selection information to the open design management server 1 using the web browser. This type selection information indicates the selected type of design work. In the open design management server 1, the design frame managing unit 34 (a) receives the type selection information, (b) extracts design work agreed with the type of design work indicated by the received type selection information among the design work shown in FIG. 13, (c) generates timeline data for displaying the extracted design work arranged in the order of a posting time, and (d) transmits the generated timeline data to the terminal device using the frontend processing unit 31 and thereby causes the terminal device 3 to display the project timeline 291 of the extracted design work (e.g. in FIG. 14, a project timeline of posts of the design work type “requirement”) on the basis of the received timeline data.

The other parts of the configuration and the behavior of the open design management server 1 in Embodiment 3 are same as or similar to those in Embodiment 1 or 2, and therefore are not explained here.

As mentioned, in Embodiment 3, posts of a specific design work can be displayed so as to arrange pieces of the specific design work in the order of posting times thereof, and consequently a user easily understands a design process.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned Embodiment 1, 2 or 3, the project managing unit 33 may be configured to generate screen data so that the project list (i.e. a list of design demands such as shown in FIG. 3) includes, for each design demand, (a) whether a proposal of a design concept has been posted for the design demand or not, (b) the number of proposals that have been posted, (c) whether a design frame has been created for a proposal of a design concept for the design demand, (d) the number of design frames that have been created, and the like, transmit the generated screen data to the terminal device 3 using the frontend processing unit 31, and cause the terminal device 3 to display a project list that includes these pieces of information (a), (b), (c), (d) and the like.

Further, in the aforementioned Embodiment 1, 2 or 3, only a specific type user can create a design frame. Alternatively, another user (i.e. a registered user or any one of a registered user and a guest user) may freely create a design frame and as a design participant may freely participate in the design. Furthermore, although only a specific type user can create a design frame, another user than a design participant (i.e. a registered user or any one of a registered user and a guest user) may be allowed to browse the design frame as well as the design participant.

Furthermore, in the aforementioned Embodiment 1, 2 or 3, an electronic bulletin board may be set up for each proposal of a design concept in order to enable to make discussion on the proposal.

Furthermore, in the aforementioned Embodiment 1, 2 or 3, the server program 21 may be stored in a portable non-transitory computer readable recording medium such as CD-ROM, and may be installed from the medium to the open design management server 1. In addition, the server program 21 may be stored in a built-on storage device (i.e. a non-transitory computer readable recording medium) such as hard disk drive in a program development terminal and may be uploaded from the terminal to the open design management server 1.

Furthermore, in the aforementioned Embodiment 1, 2 or 3, the open design management server 1 includes the database. Alternatively, instead of the open design management server 1, another device may include the database server 35 and a storage device in which the user data 22, the project data 23 and the design frame data 24 are stored; and the user managing unit 32, the project managing unit 33, and the design frame managing unit 34 may perform network communication with the database server 35 included in the another device and thereby perform a data operation to the database in the another device.

Furthermore, in the aforementioned Embodiment 2, a link to either a design project or a group included in a group or a root (i.e. a reference to a design project or a group) may be included in another group. In such a case, (a) an original design project or an original group of a link and (b) a group that includes the link are specified by a user operation to the terminal device 3; a link addition request is transmitted from the terminal device 3 to the open design management server 1, and the link addition request indicates (a) the original design project or the original group and (b) the group that includes the link; and in the open design management server 1, on the basis of the link addition request, link data of the link (i.e. data that indicates the original design project or the original group) is stored in the project data 23 so as to associate the link data with a group ID of the aforementioned another group. In such a case, for example, the screen data is generated so as to display an icon or the like of either the original design project or the original group in a list of design projects and/or groups included in the aforementioned another group. Further, as an icon of the link, (a) an icon may be used as same as an icon of either the original design project or the original group or (b) a copy icon may be used, the copy icon is an icon obtained by adding a mark (e.g. an arrow mark or the like) to an icon of either the original design project or the original group, and the mark indicates that this is a link.

What is claimed is:

1. An open design management server, comprising:
a communication device;
a frontend processing unit that receives a post and a request using the communication device, the post and the request transmitted from plural terminal devices operated by plural users; and
a project managing unit that manages a design project using a database and performs a process corresponding to the received post or request for the design project;
wherein the project managing unit
(a) transmits design demand posting screen data using the frontend processing unit to the terminal device, and creates a design project for a design demand in the database when a post of the design demand is received by the frontend processing unit from the terminal device, the design demand inputted to an input field displayed on the basis of the design demand posting screen data in the terminal device;
(b) transmits proposal posting screen data of a solution for the design demand using the frontend processing unit to the terminal device, and stores a proposal of a design concept in the database so as to associate the proposal with the design demand when a post of the proposal is received by the frontend processing unit from the terminal device, the proposal inputted to an input field displayed on the basis of the proposal posting screen data in the terminal device, and the one or plural proposals enabled to be associated with the single design demand;
(c) creates a design frame in the database when a creation request of a design frame for the proposal is received by the frontend processing unit from the terminal device, and stores the created design frame so as to associate the design frame with the proposal, the design frame capable of describing a series of design work materializing the design demand in accordance with the proposal, and the one or plural design frames enabled to be associated with the single proposal; and
(d) transmits screen data to the terminal device for displaying a relationship between the design demand and the proposal associated with each other in the database, and a relationship between the proposal and the design frame associated with each other in the database, and causes the terminal device to display the relationships.

2. The open design management server according to claim 1, wherein if the plural proposals are associated with the single design demand in the database, the project managing unit transmits screen data to the terminal device for displaying, in one screen, relationships between the design demand and the proposals associated with each other in the database and causes the terminal device to display the relationships in one screen.

3. The open design management server according to claim 1, wherein if the plural design frames are associated with the single proposal in the database, the project managing unit transmits screen data to the terminal device for displaying, in one screen, relationships between the proposal and the design frames associated with each other in the database and causes the terminal device to display the relationships in one screen.

4. The open design management server according to claim 1, wherein the project managing unit transmits screen data to the terminal device for (a) displaying a relationship between the proposal and the design frame associated with each other in the database and (b) displaying a status and/or progress of the design work in the design frame, and causes the terminal device to display the status and/or the progress of the design work with the relationship between the proposal and the design frame.

5. The open design management server according to claim 1, wherein if a user of the terminal device that transmitted the creation request of the design frame is a specific type of user, the project managing unit creates the design frame, stores the created design frame so as to associate the created design frame with the proposal; and if the user of the terminal device that transmitted the creation request of the design frame is not a specific type of user, the project managing unit does not create the design frame for this creation request.

6. The open design management server according to claim 1, wherein the frontend processing unit receives the creation request of the design frame from the terminal device of another user than a user who posted the design demand.

7. The open design management server according to claim 1, wherein:
the project managing unit manages a group of design projects in the database; and
the group is capable of including one or plural groups and one or plural design projects.

8. The open design management server according to claim 1, further comprising a design frame managing unit that manages the design frame using design frame data;
wherein the design frame managing unit
(a) generates screen data of the design frame on the basis of the design frame data, transmits the generated screen data to the terminal device, and causes the terminal device to display the design frame;
(b) stores a received post of the design work as a part of the design frame data so as to associate the received post with the design work in the database when the post is received by the frontend processing unit;
(c) transmits first timeline data to the terminal device for displaying the design work of the design frame so as to arrange the design work in an order of a posting time and causes the terminal device to display the design work arranged in an order of posting time on the basis of the first timeline data; and
(d) receives type selection information from the terminal device, extracts design work agreed with a type selected by the type selection information from the design work of the design frame, transmits second timeline data to the terminal device for displaying the extracted design work of the design frame arranged in an order of a posting time, and causes the terminal device to display the design work arranged in an order of a posting time on the basis of the second timeline data.

9. A non-transitory computer readable recording medium storing a server program; the server program causes a computer in a server to act as:
a frontend processing unit that receives a post and a request using a communication device of the server, the post and the request transmitted from a terminal device; and
a project managing unit that manages a design project using a database and performs a process corresponding to the received post or request for the design project;
wherein the project managing unit
(a) transmits design demand posting screen data using the frontend processing unit to the terminal device, and creates a design project for a design demand in the database when a post of the design demand is received by the frontend processing unit from the terminal device, the design demand inputted to an input field displayed on the basis of the design demand posting screen data in the terminal device;
(b) transmits proposal posting screen data of a solution for the design demand using the frontend processing unit to the terminal device, and stores a proposal of a design concept in the database so as to associate the proposal with the design demand when a post of the proposal is received by the frontend processing unit from the terminal device, the proposal inputted to an input field displayed on the basis of the proposal posting screen data in the terminal device, and the one or plural proposals enabled to be associated with the single design demand;
(c) creates a design frame in the database when a creation request of a design frame for the proposal is received by the frontend processing unit from the terminal device, and stores the created design frame so as to associate the design frame with the proposal, the design frame capable of describing a series of design work materializing the design demand in accordance with the proposal, and the one or plural design frames enabled to be associated with the single proposal; and
(d) transmits screen data to the terminal device for displaying a relationship between the design demand and the proposal associated with each other in the database, and a relationship between the proposal and the design frame associated with each other in the database, and causes the terminal device to display the relationships.
